(19) United States
(12) Patent Application Publication
(10) Pub. No.: US 2010/0145851 A1
(43) Pub. Date: Jun. 10, 2010

(54) TRANSACTION SYSTEM WITH ENHANCED INSTRUCTION RECOGNITION

(75) Inventors: Johannes Janse Van Rensburg, Stellenbosch (ZA); Cornilius Johannes Badenhorst, Cape Town (ZA)

Correspondence Address: Ballard Spahr LLP, SUITE 1000, 999 PEACHTREE STREET, ATLANTA, GA, 30309-3915, US

(73) Assignee: FUNDAMO (PROPRIETARY) LIMITED, Cape Town (ZA)

(21) Appl. No.: 12/448,453

(22) PCT Filed: Dec. 8, 2007
(86) PCT No.: PCT/IB2007/003825

§ 371 Date: Jan. 6, 2010

(30) Foreign Application Priority Data
Dec. 18, 2006 (ZA) 2006/10618

(51) Int. Cl. G06Q 40/00; G06N 5/02; G06F 15/16

(52) U.S. Cl. 705/42; 706/54; 709/206

(57) ABSTRACT

A transaction system is provided in which a plurality of participating system members each has access to a communications device so as to operatively communicate via an associated network with a computerized server in order to instruct the initiation or conduct of a transaction, typically a financial transaction, by operation of the computerized server consequent on data inputted by a particular system member. The system includes at least one data base in which there is retained data relating to at least some possible or previous transactions or both that may be conducted by the particular system member. Selection means are provided for selecting one of said possible or previous transactions that best represents data inputted in respect of any particular target transaction on the basis of artificial intelligence such that data inputted in different ways or with different degrees of accuracy can result in the same target transaction being selected by the selection means. The selected transaction is communicated to the particular system member whose confirmation is required of the correctness or otherwise of the selected target transaction.

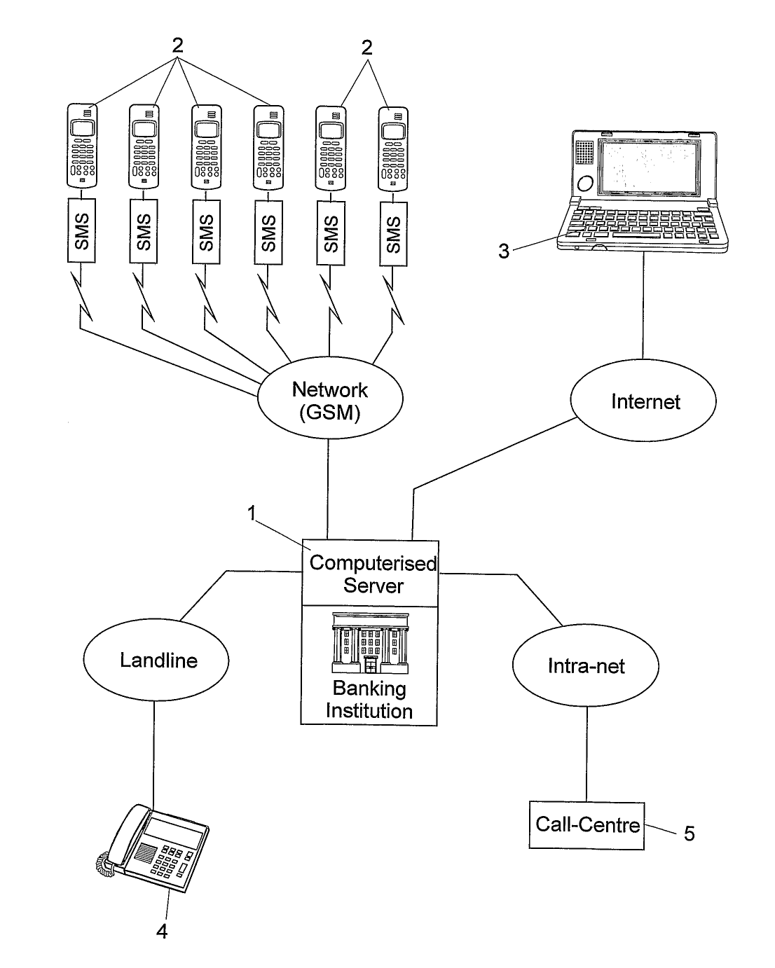

### FIELD OF THE INVENTION

This invention relates to a transaction system with enhanced instruction recognition and, more particularly, but not exclusively, to a transaction system that is capable of handling, in amongst others, financial transactions.

Still more particularly, the invention is concerned with a transaction system in which instruction data is typically inputted by way of a keypad or touch screen of a suitable communications device, often a wireless communications device such as a mobile telephone, in particular a cellular telephone.

### BACKGROUND TO THE INVENTION

The inputting of instruction data for the purpose of conducting a transaction, most commonly a financial transaction, is usually done by way of a machine-human interface, most typically a keypad or touch screen of some sort or another. The data inputted is usually divided into data conveying different items of information and a separate field, or block, is often provided for the entry of each different item of information. Such fields, could, for example, be those identifying a transaction type; a target beneficiary; the amount of the transaction; a security item such as a PIN (personal identification number); and optionally a reference item.

Whilst, with the aid of an “auto-fill” feature, it may not be necessary to complete the full set of integers that make up each item of data, as a general rule, a computerized system into which the data is inputted does require 100 percent accuracy of the individual integers that are in fact inputted.

With the development of technology and the result that “high-tech” equipment is becoming available to a broader spectrum of people, so are the natural abilities of some users of the relevant equipment are challenged in that they may find operation of the equipment difficult, or at least the accurate inputting of each integer difficult.

Also, understanding the system's interface becomes more difficult when the required inputs must be captured on a small screen—for example the screen of a phone, to fill in specific fields or blocks. The result may be a considerable amount of frustration and wastage of time in consequence of one or other integers being incorrectly inputted.

### OBJECT OF THE INVENTION

It is an object of this invention to provide a transaction system with enhanced instruction recognition wherein at least some inaccuracies in data inputted into the system are accommodated.

### SUMMARY OF THE INVENTION

In accordance with one aspect of this invention there is provided a transaction system of the type in which a plurality of participating system members each has access to a communications device so as to operatively communicate via an associated network with a computerized server in order to instruct the initiation or conduct of a transaction by operation of the computerized server consequent on data inputted by a particular system member, the system including at least one data base in which there is retained data relating to at least some possible or previous transactions or both that may be conducted by the particular system member, the system being characterized in that selection means are provided for selecting one of said possible or previous transactions that best represents data inputted in respect of any particular target transaction on the basis of artificial intelligence such that data inputted in different ways or with different degrees of accuracy can result in the same target transaction being selected by the selection means; and in that means are provided for communicating the selection to the particular system member; and confirmation means are provided for activation by the particular system member in the event of the correct target transaction having been selected.

Further features of the invention provide for the possible transactions to include historic transactions of a group of participating system members; for the possible transactions to include a set of transactions provided by or on behalf of a participating system member and inputted into the data base using any suitable or appropriate vehicle; for the transactions to include financial transactions; for the communications device to be a mobile, typically a wireless, communications device such as a mobile telephone, in particular, a cellular telephone; for the transaction system to be a banking type of system; for the data base to be retained either on the communications device or, alternatively, as a separate personal data base record on a general data base associated with the computerized server; and for the input to be reflected on a display screen that is optionally, and preferably, devoid of any special fields such as in the instance that instant messaging is utilized as the communications medium.

It is another feature of the invention that the computerized server may, according to the particular details of any particular transaction, selectively omit the requirement of a PIN being inputted.

As a general rule, the communications device will be a mobile device such as a telephone having other purposes and, in such an instance, a communications device with different modes of operation that are accessible by way of a menu or other selection process such that the transactions conducted according to the invention are carried out (not necessarily exclusively) from a particular transaction mode selected for the purpose.

In accordance of a second aspect of the invention there is provided a method of selecting a target transaction to be conducted in a transaction system of the general nature outlined above wherein incomplete, inaccurate or informal data is inputted into a communications device that is in communication with a data base containing data relating to at least some possible or previous transactions or both that may be conducted by a particular system member, the method being characterized in that it includes the steps of comparing the incomplete, inaccurate or informal data with data retained in the data base; selecting one of said possible or previous transactions that best represents data inputted in respect of the particular target transaction on the basis of artificial intelligence; and communicating the selection to the communications device or operator thereof for confirmation, amendment, or rejection, as the case may be, by the operator of the communications device.

Further features of this aspect of the invention correspond to those indicated for the first aspect and are not repeated here.

Briefly, the invention therefore proposes a technical solution to the technical difficulty outlined above wherein the interface between a user and the computerised server does not dictate required input to the user but rather allows the user to input data that in the mind of the user describes the target transaction. The system then attempts to determine the target transaction through a form of artificial intelligence on the basis of data retained in the data base that will generally include possible transactions and historic transactions that may be repeated. The historic transactions may be limited to historic transactions of the particular participating system member or it may be historic transactions of a group of participating system members, optionally a group having particular characteristics in common.

Prior to carrying out the transaction the system is programmed to check with the user that the correct transaction has been selected and may, at that stage, require the input of a PIN or other identification data. However, in instances of regular or small transactions the system may dispense with such identification requirement. The system may also, on the basis of previous transactions, particularly previous repeated transactions such as monthly or weekly transactions of a particular type or to a particular beneficiary, suggest to the user transactions that on the basis of artificial intelligence, would appear to the due for payment and simply ask for confirmation to conduct the relevant transactions or request the input of a variable amount that is due for a particular payment.

It will be understood that the term “artificial intelligence” includes all types of computer-generated responses based on a selection of available possibilities including those referred to as “pattern recognition” and “chatterbot”.

At a practical level with technology at its present state of development, a system according to the invention could typically include an instant messaging client on mobile devices for use in conducting transactions; an instant messaging server; artificial intelligence software on a server; transacting patterns used by the artificial intelligence software on a data base; a data base with possible and previous transactions of relevant participating system members as well as their financial accounts data; and a security server for use in instances in which identification is determined as being required.

In order that the invention may be more fully understood an expanded description of one implementation thereof follows with reference to the accompanying drawing.

### BRIEF DESCRIPTION OF THE DRAWING

The accompanying drawing is a schematic diagram illustrating a typical transaction system in which the invention may be employed.

### DETAILED DESCRIPTION WITH REFERENCE TO THE DRAWING

Simply by way of example, and as indicated in the drawing, the instant application of the invention is described as being applied to a financial transaction system including a computerized server (1), in this instance of a banking institution, that is accessible for the purposes of carrying out financial transactions by way of cellular telephones (2); a computer (3) communications over the Internet; a suitable telephone (4) communicating over a landline; and call centres (5) irrespective of the communication vehicle employed between it and the computerized server.

Also, in the application of the invention described herein the format of transmitting messages from the cellular telephone will generally be by way of a suitable data channel such as GPRS/3G, whereas, it will be appreciated, that any other appropriate format or protocol can be employed, the format being irrelevant insofar as the principles of operation of the invention are concerned.

In the instance that the communications device has its own processor or microprocessor and memory, the relevant data as to possible and previous transactions carried out any by any particular system member may be retained on the communications device itself or, more commonly, will be retained in the central general data base of the computerized server that will typically be the server of the banking institution. In the case of a cellular telephone, the data may, however, be retained in a memory within the cellular telephone, or even in a memory associated with the usual SIMM card, where same is present. It is also possible that the data can be retained in a portable memory unit such as an I-pod, for example. The exact form in which the data base exists physically is irrelevant to the invention.

As a general rule, the communications device will have a display screen forming part of the user interface and when the communications device has various different functions that it may serve, the function of conducting a financial transaction will generally be selected from a menu that can be displayed on the screen or by any other suitable selection means. Alternatively, the function can be selected interactively by voice (either synthesized or recorded) and keypad input.

In prior art transaction systems of this type, it has been common for a transaction to the carried out by selecting a type of transaction from a standard type of menu structure wherein each item has associated with it a preset standard message which is a substantially complete instruction only requiring a small amount of data to be added in order to complete it, for example, the identity of the recipient and the amount to be transferred. The identity of the recipient may even be selected from a sub-menu in which there is a custom list of potential recipients. Nevertheless, the composite message that needs to be compiled does require at least the selection of the recipient and the amount of the transaction to be inputted with a hundred percent accuracy.

In contradistinction, the present invention allows incomplete, inaccurate or informal data to be inputted and the data base to be scanned for permissible or prior transactions that may have been conducted by a particular participating system member. This incomplete, inaccurate or informal instruction input can therefore most conveniently be communicated to the computerized server by way of instant messaging.

Simply by way of example, the following are typical inputs that are required in order to conduct a financial transaction in an existing transactional system:
1. Transaction type—for example balance, payment, transfer etc.
2. Beneficiary/target account.
3. Amount.
4. PIN—used to authorise the transaction, as may be required, or not.
5. An optional reference to the transaction.

It is typical for these inputs to be required in specific fields and sometimes, to be inputted in a specific sequence.

The present invention, however, proposes to allow the participating system member to capture non prescribed inputs, and typically, in any sequence and in a way in which the user perceives the transaction.

Thus, a participating system member who wants to perform a balance enquiry may simply input any one of “b” or “bal” or “bl”. This information would be compared to previous transactions, or at least a set of possible transactions and the balance could immediately be supplied or the question asked “Do you require the balance of your account?”.

A participating system member who wishes to make a payment would be allowed to capture “p” or “pay” or “pm”—or nothing at all since the system may determine from the beneficiary that only a payment transaction can be performed. A participating system member may for example capture “peter 200” and the system would determine that a payment of R200 must be made to Peter's account.

Whether a PIN is required as part of a transaction may also be determined by the system of the invention—certain transactions to certain beneficiaries may be regarded (based on a risk score determined by taking into account the amount, beneficiary and whether it is a repeat transaction or not) to omit the requirement of a PIN. The participating system member therefore may, as for other inputs, not be forced to capture the PIN in a specific field in a specific sequence since the system may only prompt for the PIN when required.

The system of the invention may use the following in trying to identify the required inputs for a transaction.

It may try and identify the transaction type from the incomplete or informal input; it will scan the input for “p”, “b”, “pm”, “pay” etc. Not finding a transaction type identifier will not necessarily result in the failure of the transaction.

It may try and determine the target/beneficiary from the incomplete, inaccurate or informal input—it will scan for example for “peter” and compare it against a list of publicly know beneficiaries (“telkom” or “edgars” may for example be know possible beneficiaries) and a list of possible beneficiaries that the participating system member may have defined and a list of beneficiaries that the participating system member has paid before.

The system of the invention would generally not rely on the correct spelling of a beneficiary name—if a user for example has captured “tlkm” the system could match it with “telkom”. If more than one possible beneficiary is found the system would use the date and amount of the transaction to make a selection between the multiple beneficiaries found. If for example it is 3 days before month end the system would query the participating system member's payment history to see if one of the potential beneficiaries were paid 3 days before month end last month to make a decision. Indeed, it is envisaged that the system could automatically suggest payments that may be due based on the time of month, week, or year and on past history.

The system of the invention will most commonly determine the amount of the transaction from the data inputted unless a regular payment of the same amount is found. In such an instance the computerised server would request confirmation that such a transaction was to be carried out (repeated)

The system of the invention could determine what security characteristics are required for a particular transaction to be authorised and could prompt the user for the appropriate identification input. The system may even determine exactly what transaction the user wants to perform but may disallow it since it may not be allowed on the channel the user is using for interaction with the system.

It is envisaged that in practice, the system of the invention will actually scan the complete data inputted in one step. Inputs that clearly match a required input (the amount for example should be easier to identify than the other inputs since it is numeric) would be immediately identified. In instances in which the inputted data does not clearly match a required input then the system would look for the most likely match.

A participating system member may for example provide the following input: “200 pay p”. The system would match 200 as the amount and “pay” as the transaction type and is then in a position to search for a beneficiary that matches “p”.

Every time the system is not able to determine what transaction the participating system member wants to perform it will prompt the participating system member for more explicit input. After the transaction is then performed the system will adapt its parameters specific to the participating system member to be able to identify the transaction correctly the next time the participating system member captures the same or similar inputted data. The system will, in other words, learn from the situations in which it could not determine the correct action.

Because the preferred system according to the invention does not prescribe the transaction inputs, nor the sequence of interaction, and learns from history, the system can be seen as an interface that is similar in some ways to a human interaction.

A simple way to visualise the implementation of the concept is to see it as an “instant messaging” (IM) conversation with the transaction system. MSN, Google talk, and Yahoo messenger are commonly used IM systems.

In such an instance there are the two options, namely those of using any instant messaging client such as MSN client, Google client or Jabber, or alternatively, the IM client may be supplied by the bank. The two options differ significantly in the security provided.

In the first instance, when a user uses any publicly available instant messaging client, the messages sent to the bank will go through the publicly used instant messaging server where it could be seen as these messages currently cannot be suitably encrypted since the clients do not have encryption capability.

On the other hand, when a participating system member is forced to download a client from the bank, the messages sent to a instant messaging server under control of the bank will be managed with better security as the instant messaging client could be written so that it has the ability to encrypt the messages. In this event the instant messaging client should be written so that it contains a unique identifier which will be sent in every message. When a message is received the bank's server will make sure there is a match between the unique identifier and the participating system member's user name and thereby provide better security.

The instant messaging client provided may also allow the normal instant messaging functions. Users, in other words, will be able to use the client to talk on MSN or Google etc.

The first alternative could be used for transactions that do not pose a risk, for example for balance enquiries, while the second alternative is better suited to making a payment to an unregistered beneficiary.

In order to conduct a transaction according to the first alternative, a participating system member would download an instant messaging client to their phone if one is not already installed. The participating system member would sign in to the instant messaging service by entering his username and password and, as may be necessary, add the bank's email to his instant messaging contact list. The bank's instant messaging system would recognise that a new user is trying to add it to their contact list and would accept the addition. The bank's name then appears on the participating system member's screen as a contact that is online.

The participating system member would then commence a “conversation” with the bank's instant messaging server.

The artificial intelligence software (say for example a chatterbot) will converse with the participating system member and query the database, as required, for information to try and determine what the participating system member wants to do.

When the artificial intelligence software has determined what transaction must apparently be done it will instruct the bank's transacting engine to perform the transaction and, having checked with the participating system member that the correct transaction has been selected, will communicate a success or failure (with reason) message (also indicating new balances) to the participating system member.

In the case of the second alternative as regards the instant messaging client, the participating system member would download the bank's instant messaging client to his phone. An application that is thus downloaded would have encryption and decryption ability and have a unique code embedded. The bank will, in such an instance, already be added as a contact for the participating system member. The procedure indicated above can then commence.

Simply as a specific example, an interaction between a participating system member and the system could commence with the participating system member communicating with the system whereupon the following dialogue could take place.

System:
Hello Mr Smith. How can I help today. (System replies to user starting a conversation.)

System member input:
b (User requests balance)

System:
The balance on you savings account is R23 546. The balance on your cheque account is R—12 008. (System replies with balance.)

System member input:
Peter again. (User captures transaction information)

System:
Please confirm that you would like to pay R234.45 to Peter's account at bank X immediately. (System determines that the user wants to perform the same transaction he has performed on the last Friday of the previous 3months.)

System member input:
Yes (system member confirms that such transaction must be performed.)

System:
Payment made to Peter's account at bank X. An e-mail notification has been sent to his cell phone. (The system determines from history that the preferred notification method of the participating system member is through e-mail.)

System member input:
Past payments. (The system is asked to suggest payments that should be performed)

System:
In the past you have done the following payments:
1: Payment of Telkom Bill for R456
2: Transfer from Cheque account to credit account so that balance in cheque account is R10 000 (System replies with transactions it thinks the participating system member may want to perform again.)

System member input:
2. (The participating system member instructs the system to perform transaction 2.)

System:
R12 456 has been transferred from your cheque account to your credit card account. The new cheque account balance is R10 000. The new credit card balance is R 2 334. (System performs transaction and provides new balances in account.)

It will thus be understood that the invention provides an extremely user friendly interface with a participating system member in which the data base associated with the particular participating system member is updated and modified so that it becomes more able to accurately interpret incomplete, inaccurate or informal inputted transaction instruction data. Of course, as indicated above, the data base could regard historic transactions of other system members, such as a particular group of participating system members, as providing possible transactions for any instructing participating system member and this facility may be particularly appropriate when new system members join the group for the system at large.

Clearly, numerous variations may be made to the system described above without departing from the scope hereof.

1. A transaction system of the type in which a plurality of participating system members each has access to a communications device so as to operatively communicate via an associated network with a computerized server in order to instruct the initiation or conduct of a transaction by operation of the computerized server consequent on data inputted by a particular system member,
wherein the system includes at least one data base in which there is retained data relating to at least some possible or previous transactions or both that may be conducted by the particular system member,
wherein selection means are provided for selecting one of said possible or previous transactions that best represents data inputted in respect of any particular target transaction on the basis of artificial intelligence such that data inputted in different ways or with different degrees of accuracy can result in the same target transaction being selected by the selection means; and
wherein means are provided for communicating the selection to the particular system member; and
confirmation means are provided for activation by the particular system member in the event of the correct target transaction having been selected.

2. A transaction system as claimed in claim 1 in which the possible transactions include historic transactions of the participating system member or a group of participating system members.

3. A transaction system as claimed in claim 1 in which the possible transactions include a set of transactions provided by or on behalf of a participating system member and inputted into the data base using any suitable or appropriate vehicle.

4. A transaction system as claimed in claim 1 in which the transactions include financial transactions.

5. A transaction system as claimed in claim 1 in which the communications device is a mobile telephone.

6. A transaction system as claimed claim 1 in which the transaction system is a banking type of system.

7. A transaction system as claimed in claim 1 in which the data base is retained on the communications device.

8. A transaction system as claim 1 in which instant messaging is utilized as the communications medium.

9. A transaction system as claimed in claim 1 in which the computerized server may, according to the particular details of any particular transaction, selectively omit the requirement of a PIN being inputted.

10. A method of selecting a target transaction to be conducted in a transaction system as claimed in any one of the preceding claims wherein incomplete, inaccurate or informal data is inputted into a communications device that is in communication with a data base containing data relating to at least some possible or previous transactions or both that may be conducted by a particular system member, the method being characterized in that it includes the steps of comparing the incomplete, inaccurate or informal data with data retained in the data base; selecting one of said possible or previous transactions that best represents data inputted in respect of the particular target transaction on the basis of artificial intelligence; and communicating the selection to the communications device or operator thereof for confirmation, amendment, or rejection, as the case may be, by the operator of the communications device.

11. A transaction system as claimed in claim 1 in which the data base is retained as a separate personal data base record on a general data base associated with the computerized server.
